(19) United States
(12) Patent Application Publication
(10) Pub. No.: US 2004/0105788 A1
(43) Pub. Date: Jun. 3, 2004

(54) Reactor for microarray

(75) Inventors: Chung-Fan Chiou, Hsinchu (TW); Bor-Iuan Jan, Pingtung (TW); Chih-Wei Ho, Miaoli (TW); Shu-Ju Yang, Hsinchu (TW)

Correspondence Address: SUGHRUE MION, PLLC, 2100 PENNSYLVANIA AVENUE, N.W., SUITE 800, WASHINGTON, DC, 20037, US

(73) Assignee: INDUSTRIAL TECHNOLOGY RESEARCH INSTITUTE

(21) Appl. No.: 10/620,360

(22) Filed: Jul. 17, 2003

(30) Foreign Application Priority Data
Dec. 3, 2002 (TW) 91135057

(51) Int. Cl. B01J 19/00

(52) U.S. Cl. 422/130

(57) ABSTRACT

A reactor for a microarray. A first member includes a first fillister for a sample solution or a microarray, a second member is removably disposed on the first member with a second fillister corresponding to the first fillister, and electrodes are disposed on the second member for contacting the sample solution.

### BACKGROUND OF THE INVENTION

1. Field of the Invention

The present invention relates to a reactor for microarray. More particularly, the present invention relates to a reactor for a microarray comprising electrodes.

2. Description of the Related Arts

Genetic information is the key to every manifestation of life, since developments related to the alignment of genetic elements include, for example, organ development, the color of hair and skin, disease occurrence, the expression or assembly of protiens, or body type are all controlled by genes. Therefore, many life science studies focus on large-scale gene expression, or fast, convienient, and accurate methods to obtain the gene information for living organisms. The information is useful for the subsequent studies such as drug development, gene therapy, and discovery of disease-related genes.

To correspond to the rapid development of life science and the great quantities of bio-information, technologies related to biochips have been improved, such as surface chemistry, fluorescent spectrometry, manufactures of biochips, microfluidic systems, bio-informatics, and molecular biology. Biochip technology is cross-field integrated, to which progress in other fields can easily contribute.

For instance, technologies related to molecular biology include sample preparation, gene sequencing, probe design, polymerase chain reaction (PCR), electrophoresis, hybridization, and so on. While process in any of the above mentioned technologiescan be extremely time-consumptive, some modifications have been achieved, for example, reagents for fast and easy sample preparation, the development of multiple capillary electrophoresis sequencers, fast gene comparison software to assist probe design, PCR microchip, and capillary electrophoresis chips for speeding up hybridization.

Biochips substantially reduce time for the diagnosis of disease or obtaining bioinformation. For example, it takes 3˜5 days to identify pathogens by cell culture. Drug resistance tests can take as many as ten or more days. With biochips, the examination time can be reduced to within six hours. However, even this reduced examination time may not meet real needs, since some some pathology may run a full course to fatality in only one to two days from diagnosis. Thus, research is devoted to shortening of examination time for biochips.

Most focus is on the most time-consuming steps of the assay. Within a six-hour assay, PCR takes 1.5 hour, nucleotide hybridization takes 4 hours, these two reactions taking 92% of the entire assay time. Therefore, to shorten the two reactions is the major task.

For example, Hybridization Helper technology (U.S. Pat. No. 5,030,557) provides helper oligonucleotides selected to bind to the target nucleic acid and impose a different secondary and tertiary structure on the target to facilitate binding of the probe thereto. The resulting hybrid of probe and target nucleic acid also exhibits a higher Tₘ than hybrids resulting from addition of the probe alone.

In addition, nucleic acid precipitating reagents proposed by Gen-Probe company (U.S. Pat. No. 5,132,207) can be added in a reaction solution to accelerate the reaction rate.

Another solution uses branched oligonucleotides multimer technology proposed by Chiron company (U.S. Pat. Nos. 5,624,802 and 5,594,118). A probe is immobilized on a chip to capture sample nucleic acid, then a branched oligonucleotides multimer complimentary to the sample nucleic acid is attached on the sample nuleic acid, and a fluorescent or radio-labeled detector for the nucleic acid is hybridized on the branched oligonulceotide multimer. One branched oligonucleotides multimer can be hybridized with tens or hundreds of detectors, enhancing the density and shortening hybridization time.

A volume exclusion agent is proposed by Microprobe (U.S. Pat. No. 4,886,741). It utilizes a reticular macrostructure composed of organic molecules to exlude hybridization buffer and concentrate the sample nucleic acid to enhance the hybridization reaction.

Becton Dickinson proposes an amphipathic hydrocarbon polymer (AHP) (U.S. Pat. No. 5,853,986), using amphipathic organic molecules to form a reticular macro-structure. The macro-structure can also exclude hybridization buffer and concentrate the sample nucleic acid to enhance the hybridization reaction.

A dynamic hybridization system (U.S. Pat. No. 6,255,050) proposed by Lorne Park Research uses semipermeable filter to immobilize probe nucleic acid. The solution containing sample nucleic acids is pneumatic or vacuum compressed to pass through the semipermeable filter. The solution flow may be delayed when passing through the semipermeable filter and this causes accumulation of sample nucleic acid around the semipermeable filter. This raises a concentration of sample nucleic acid and then enhances hybridization rate, since sample nucleic acid not complimentary to the probe nucleic acid can pass through the semipermeable filter.

U.S. Pat. Nos. 5,728,532, 5,849,486, 6,017,696, and 6,099,803, proposed by Nanogen, attract negative bio-molecule by voltage to raise local concentration around electrodes and increase collisions with a bio-probe immobilized on the surface. The purpose of increasing the hybridization rate can thus be achieved. In addition, a reverse voltage is added to exclude negative bio-molecules. A single nucleotide difference can be recognized by controlling the voltage.

U.S. Pat. No. 6,238,910 proposed by Genomic Solution controls the bio-moleucle in microfluidics by temperature and increases collisions between bio-molecules to mix bio-molecules and increase the hybridization rate.

U.S. Pat. Nos. 6,258,593 and 6,186,659 proposed by Agilent direct to a carrier immobilizing device for the hybridization of bio-molecules. The device provides sufficient space for the hybridization of bio-molecules. In addition, the sample can be mixed by air-bubble promoting solution. Moreover, the device provides convenient management of the reaction.

Furthermore, U.S. Pat. No. 6,162,400 enhances the mixing of sample molecules and collisions with bio-molecules immobilized on the carrier by centrifugation of the sample solution.

The above mentioned methods enhance hybridization rate by increasing nucleic acid concentration, stretching sample molecules, combining branched structures, increasing collision rate by circulation, and so on. However, these methods have limitations in practice, including the requirement for large quantities and frequently inconsistent results. There is, therefore, a clear need to improve hybridization reaction.

### SUMMARY OF THE INVENTION

It is therefore a primary object of the present invention to provide a reactor for a microarray to provide more consistent hybridization reactions from only a small amount of sample solution.

In one aspect of the present invention, the reactor comprises a first member or a carrier comprising a fillister for a sample solution, a second member or a lid disposed on the first member, and two or more electrodes disposed on the second member to contact the sample solution. The first and the second members can be integrally formed to provide a space with volume for the sample solution. With the reactor for a microarray of the present invention, one or more electrical fields can be applied to promote the molecules in the sample solution to move in accordance with the electrical field density, direction or frequency. The movement of the molecules enhance the mixing of the solution and increase collisions of molecules to enhance reaction rate and shortening the reaction time.

In another aspect of the present invention, the reactor for microarray comprises a first member or a carrier comprising a first fillister for a microarray with a reaction region thereon, and a second member or a lid disposed movably on the first member with a second fillister corresponding to the reaction region with two or more electrodes to contact the sample solution. One or more electrical fields can be applied by the electrodes to promote the molecules in the sample solution to move in accordance with the electrical field density, direction or frequency.

### BRIEF DESCRIPTION OF THE DRAWINGS

The present invention will be more fully understood and further advantages will become apparent when reference is made to the following description of the invention and the accompanying drawings in which:

FIGS. 1A-1E are diagrams showing five arrangements of the electrodes.

FIGS. 2A-2E are diagrams showing a preferred embodiment of the present invention. FIGS. 2A-2B show a lid, FIGS. 2C-2D show a carrier; FIGS. 2A, 2C are vertical views, FIGS. 2B, 2D are front views, FIG. 2E is a cross-section of A-A′ in FIG. 2C.

FIGS. 3A-3D show other embodiments of the present inventon. FIGS. 3A-3B show a lid, FIGS. 3C-3D show a carrier; FIGS. 3A, 3C are vertical views, FIGS. 3B, 3D are front views.

FIGS. 4A-4B are photographs showing hybridization results of biological molecule probe in different concentration (0.05, 0.1, and 0.5 μM). The biological molecule sample labeled with fluorescence has a concentration of 1 μM. FIG. 4A is performed under alternating voltage ±2.5 V, 60 Hz for 30 minutes using the reactor of the present invention; and FIG. 4B is performed using the conventional molecular biology method for 30 minutes.

FIGS. 5A-5B are photographs showing hybridization results of biological molecule probe in different concentration (0.01, 0.05, 0.1, and 0.5 μM). The biological molecule sample labeled with fluorescence has a concentration of 0.5 μM. FIG. 5A is performed under alternating voltage ±10 V, 60 Hz for 30 minutes using the reactor of the present invention; and FIG. 5B is performed using the conventional molecular biology method for 30 minutes.

FIGS. 6A-6B are photographs showing hybridization results of biological molecule probe in different concentration (0.05, 0.1, and 0.5 μM). The biological molecule sample labeled with fluorescence has a concentration of 1 μM. FIG. 6A is performed under alternating voltage ±25 V, 60 Hz for 30 minutes using the reactor of the present invention; and FIG. 6B is performed using the conventional molecular biology method by 30 minutes.

FIGS. 7A-7E are photographs showing hybridization results of biological molecule probe in different concentration (0.01, 0.05, 0.1, and 0.5 μM). FIGS. 7A-7D are performed using the conventional molecular biology method for 4 hours at 40° C. and the biological molecule sample labeled with fluorescence has a concentration of 0.5 μM (FIG. 7A), 1.0 μM (FIG. 7B), 5.0 μM (FIG. 7C), and 10 μM (FIG. 7D). FIG. 7E is performed under alternating voltage ±10 V, 60 Hz for 30 minutes at room temperature using the reactor of the present invention, and the biological molecule sample labeled with fluorescence has a concentration of 0.5 μM.

FIGS. 8A-8F are photographs showing the results of hybridization reaction with a sample of 10 nM. FIG. 8A is performed using the reactor of the present invention under alternating voltage ±10V, 60 Hz for 30 min; FIGS. 8B-8F are performed using conventional hybridization reactor for 1 hour (FIG. 8B), 2 hours (FIG. 8C), 4 hours (FIG. 8D), 12 hours (FIG. 8E), and 16 hours (FIG. 8F).

FIGS. 9A-9B are photographs showing the hybridization results of three different biological molecule probe A103, O3, and P3 in a concentration of 0.5 μM. The biological molecule sample labeled with fluorescence has a concentration of 5 μM. FIG. 9A is performed using the reactor of the present invention under alternating voltage ±10 V, 60 Hz for 30 minutes; FIG. 9B is performed using the conventional molecular biology method for 30 minutes.

### DETAILED DESCRIPTION OF THE INVENTION

Without intending to limit it in any manner, the present invention will be further illustrated by the following description.

The reactor for microarray in the present invention features two or more electrodes to provide one or more electrical fields to promote the movement of the molecules of the sample solution in the reactor. Collisions of molecules increases and this shortens the reaction time.

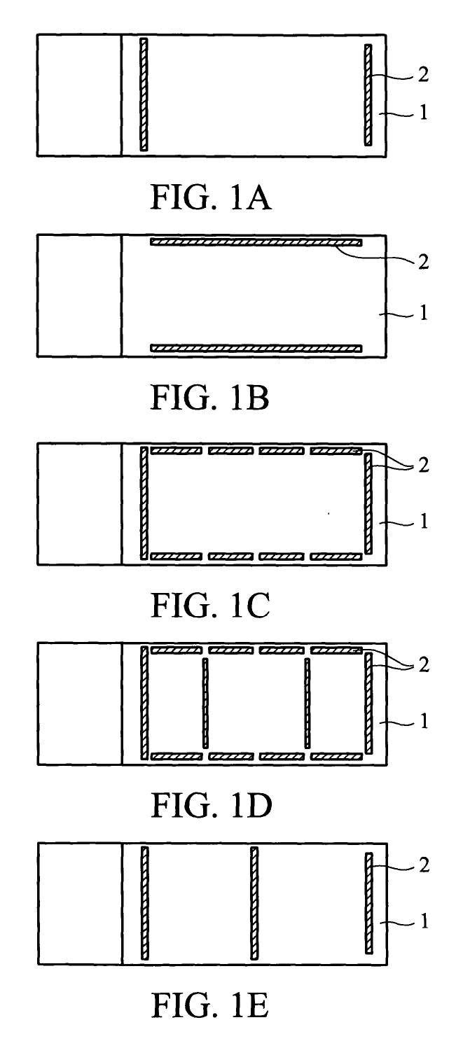

The electrodes on the reactor of the present invention can be placed as shown in FIGS. 1A-1E. In a lid 1, one pair of electrodes 2 can be arranged as shown in FIG. 1A or 1B, or two or more electrodes 2 can be arranged as shown in FIGS. 1C, 1D, or 1E. It is understood that the arrangement can be modified by those skilled in the art. The electrode can be, but is not limited to, Au, Ag, Cu, Ni, Pt, or stainless steel. The direction, density, or frequency of the electrical field can be modulated manually or programmed by software. For example, the direction of the electrical field can be modulated by choosing any two electrodes, wherein cathode or anode can be changed between the two electrodes, or using alternating current. The electropotential can be modulated to obtain different electrical field densities such as 0˜200 V. The frequency of the electrical field direction can be modulated to regulate the time of electrical field to the sample solution.

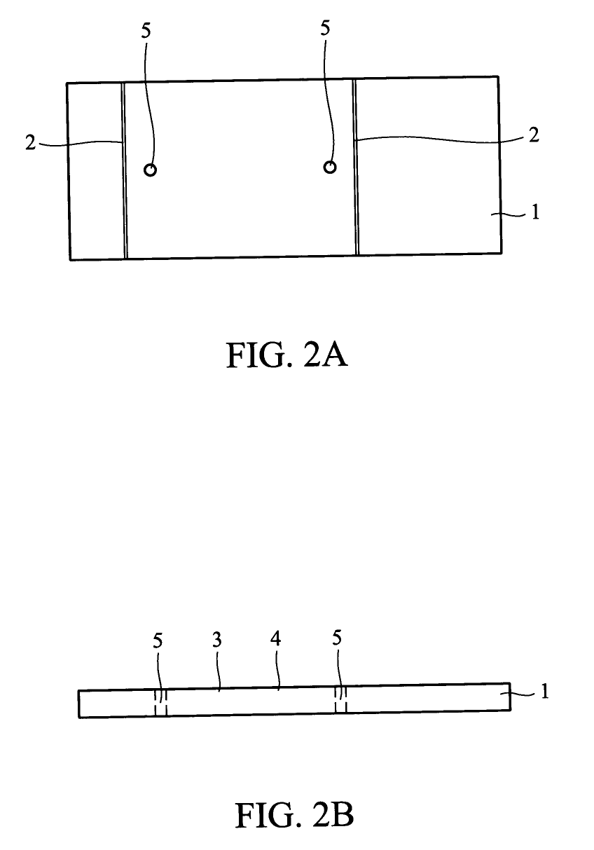

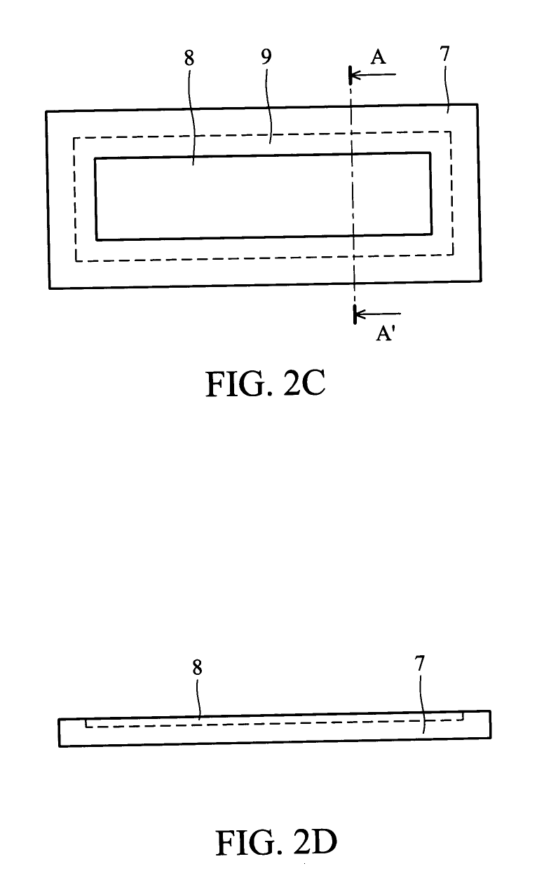

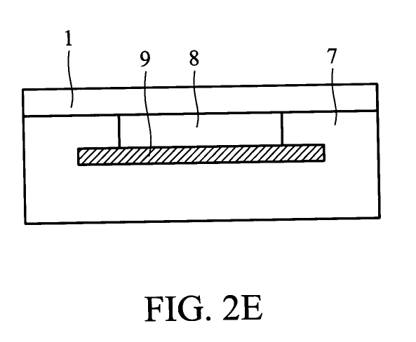

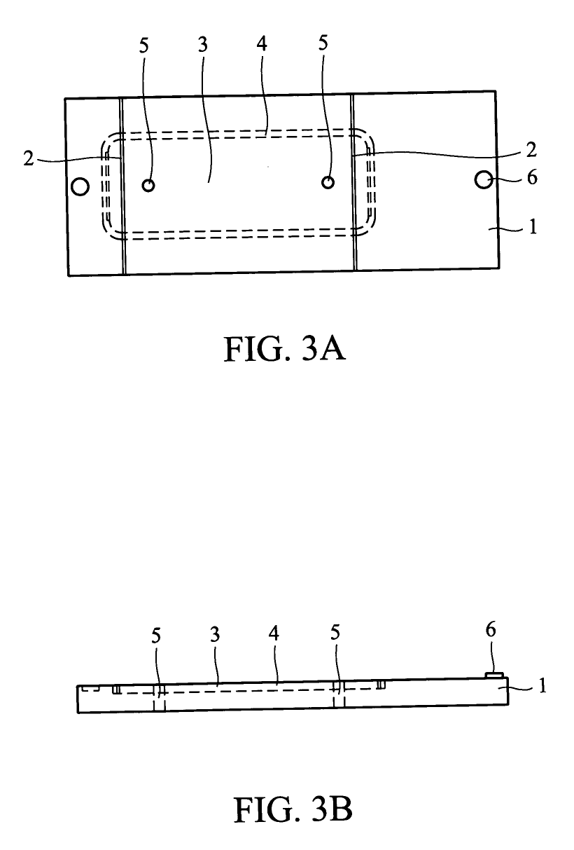

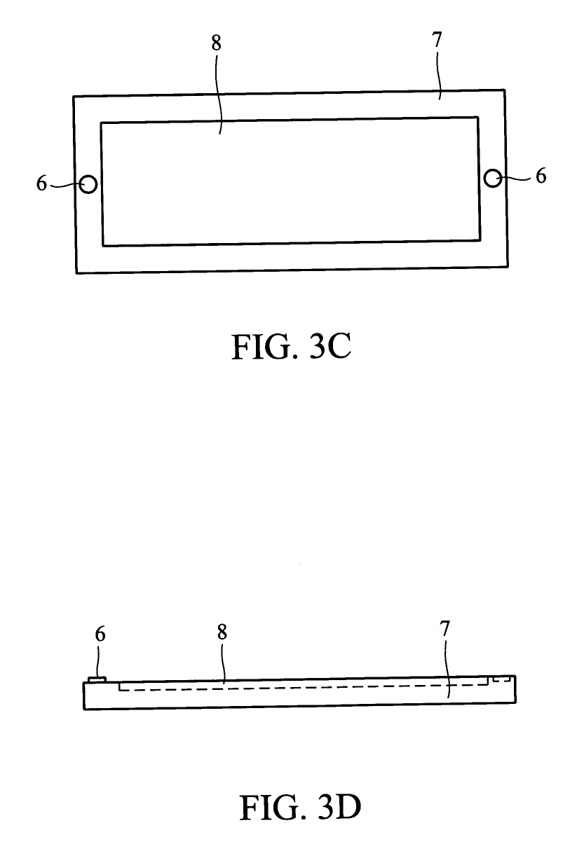

In one preferred embodiment of the present invention, as shown in FIGS. 2 and 3, the reactor comprises a first member, a second member, and two or more electrodes. The first member is the carrier 7 as shown in FIGS. 2C, 2D, 3C, or 3D. The second member is the lid 1 as shown in FIGS. 2A, 2B, 3A, or 3B. The lid 1 and the carrier 7 can be made of organic or inorganic materials. The organic material can be, but is not limited to, resin, synthetic resin, or synthetic polymer, wherein said synthetic polymer is polyethylene, polystyrene, polypropylene, or polyvinyl choride. The inorganic material includes, but is not limited to, metals, ceramics, silicon, or glass. Two preferred embodiments of the presnt invention are described in detail below.

One preferred embodiment is shown in FIGS. 2A-2E, FIGS. 2A-2B are diagrams showing a lid 1, FIGS. 2C-2D are diagrams showing a carrier 7, and FIGS. 2A, 2C are vertical views, FIGS. 2B, 2D are front views, and FIG. 2E is a cross-section of A-A′ in FIG. 2C. As shown in FIGS. 2C, 2D, and 2E, microarray 9 is embedded in carrier 7, and fillister 8 is formed therein to bear a sample solution. The margin of fillister 8 can be an O-ring to prevent the leakage of the sample solution. Fillister 8 provides enough space for the movement of the molecules. In FIGS. 2A and 2B, one pair of electrodes 2 is arranged on lid 1 corresponding to fillister 8. If more than one pair of electrodes, or even one more electrode are arranged on lid 1, it can be designed or practiced in combination. Fillister 8 becomes a closed space when lid 1 and carrier 7 are combined together. If desired, a plurality of pores 5 can be designed on lid 1 corresponding to fillister 8 to input or output sample solution or washing solution. In the example of the present invention, two reactions are performed in the slide, so two pores 5 are arranged on lid 1. The pores provide an opening for sample solution or washing solution. In addition, lid 1 and carrier 7 can be formed integrally to provide a space with a volume.

Other embodiments of the present invention are shown in FIGS. 3A-3D. FIGS. 3A-3B show a lid, FIGS. 3C-3D show a carrier; FIGS. 3A, 3C are vertical views, FIGS. 3B, 3D are front views. In FIGS. 3C and 3D, first fillister 8 is on the surface of carrier 7 to bear a microarray. In the example of the present invention, fillister 8 is the size of a slide. The two ends of carrier 7 have links 6 for connection of lid 1 and carrier 7. In FIGS. 3A-3B, a second fillister 3 is formed on lid 1 for sample solution corresponding to the first fillister 8. The margin 4 of the second fillister 3 can be the same material of lid 1, or an O ring to prevent the leakage of the sample solution. The second fillister 3 can provide sufficient space for hybridization of biological moleucles. Lid 1 has a pair of electrodes 2 in the second fillister 3. If more than one pair of electrodes or even one more electrode are arranged on lid 1, it can be designed or practiced in combination. Electrodes 2 are arranged on the two sides of the second fillister 3. Lid 1 is movably disposed on carrier 7 by linker 6. In addition, the second fillister 3 becomes a closed space when lid 1 and carrier 7 are combined together. If desired, a plurality of pores 5 can be designed on lid 1 corresponding to the second fillister 3 to input or output sample solution or washing solution. In the example of the present invention, two reactions are performed in the slide, so two pores 5 are arranged on lid 1. The pores provide openings for sample solution or washing solution.

Moreover, no matter what kind of materials lid 1, carrier 7, or electrodes 2 are, they are inert to sample solution or washing solution.

The sample solution used herein includes organic, inorganic, or biological molecules. The molecules can be charged or neutral. The organic molecules include, but are not limited to, organic acid, organic alkali, or amino acid. The inorganic molecules include, but are not limited to, metal ion or inorganic salt. The biological molecules include, but are not limited to, nucleic acid, oligonucleotide, protein or peptide.

The hybridization system using the reactor of the present invention further comprises a power supply for regulating the electrical field, the frequency of the alternating current, and the direction of the electrical field. The reactor of the present invention features an extra electrical field which continuously changes direction to move the charged biological moleucle or particles, even neutral moleucles, in a given area. The movement results in an increased collision rate. In addition to disturbing the fluid, it obviates the need to raise the concentration of the sample nucleic acid or fine micromanufacturing. The reaction temperature or total circulation is not elevated.

A practical example is described below.

### EXAMPLE

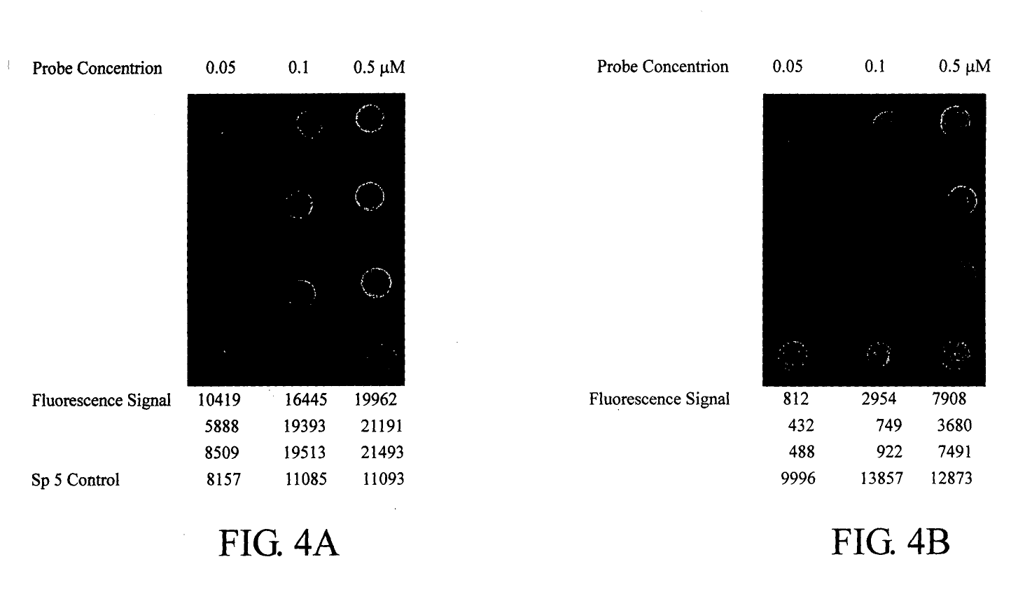

Using the reactor of the present invention with a power supply to regulate the electrical field, the frequency of the alternating current, and the direction of the electrical field, hybridization was performed and compared with conventional hyubridizaiton as shown in FIGS. 4˜9.

First, the results are compared in different probe concentration, with the same sample concentration. The concentration of biological molecule probe is 0.05, 0.1, or 0.5 μM. The fluorescent-labeled sample is 1 μM. The result shown in FIG. 4A was acheived using the reactor for microarray of the present invention under alternating voltage ±2.5 V, 60 Hz for 30 min. The result shown in FIG. 4B was acheived using the conventional hybridization method for 30 min. Comparing the two results, the biological molecule hybridization rate is effectively raised by the reactor and method of the present invention. The reactor of the present inveniton enhances the hybridization rate over 75%, or even over 99%. In contrast, the result obtained by the conventional hybridization method is not consistant.

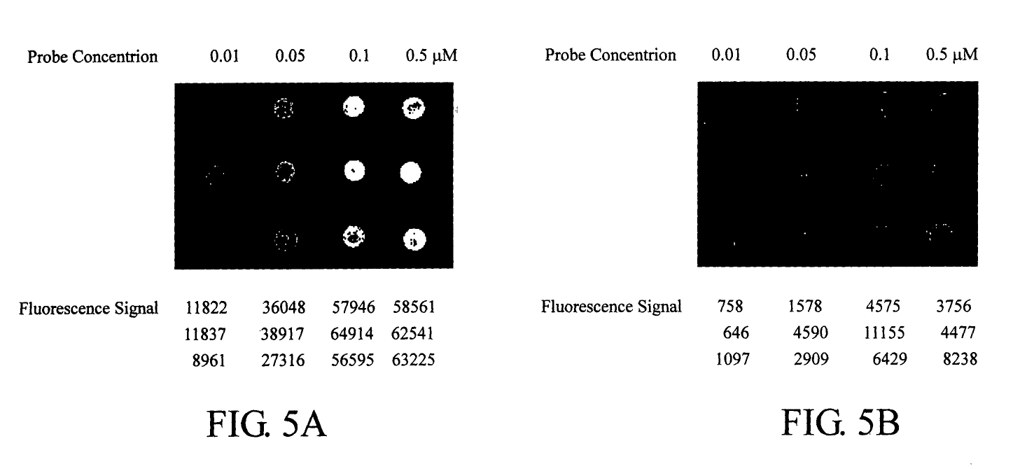

Next, the sample concnetratin is decreased to 0.5 μM. The biological molecule probe is 0.1 or 0.5 μM. The results of the reactor of the present invention under alternating voltage ±10V, 60 Hz for 30 min are shown in FIG. 5A. The results of the conventional hybridization method for 30 min are shown in FIG. 5B. With low sample concentration but high alternating voltage, the reactor of the present invention provides better hybridization than the conventional method.

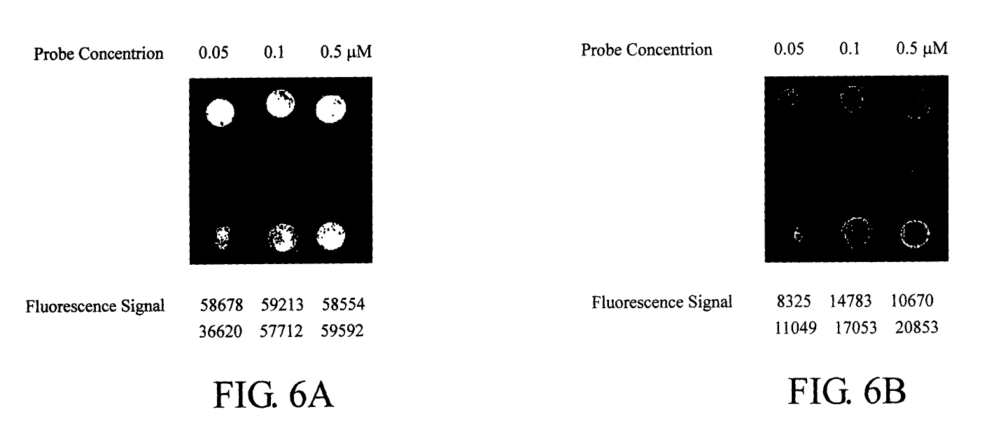

In addition, the results are still compared with different probe concentration, while at the same sample concentration. The biological molecule probe is 0.05, 0.1, or 0.5 μM. The fluorescent-labeled sample is 1 μM. The result shown in FIG. 6A was acheived using the reactor for microarray of the present invention under alternating voltage ±25 V, 60 Hz for 30 min. The result shown in FIG. 6B was acheived using the conventional hybridization method for 30 min. Comparing the two results, the biological molecule hybridization rate is effectively raised by the reactor and method of the present invention.

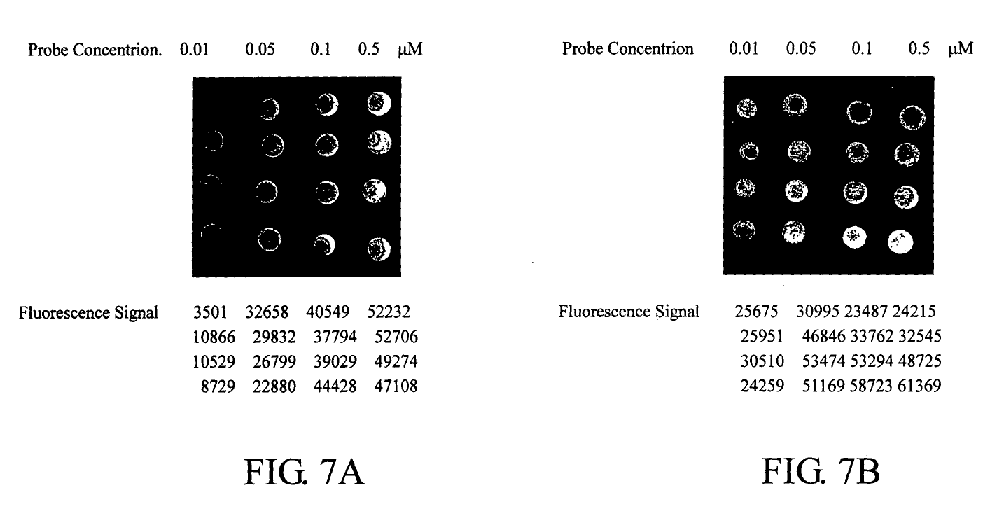

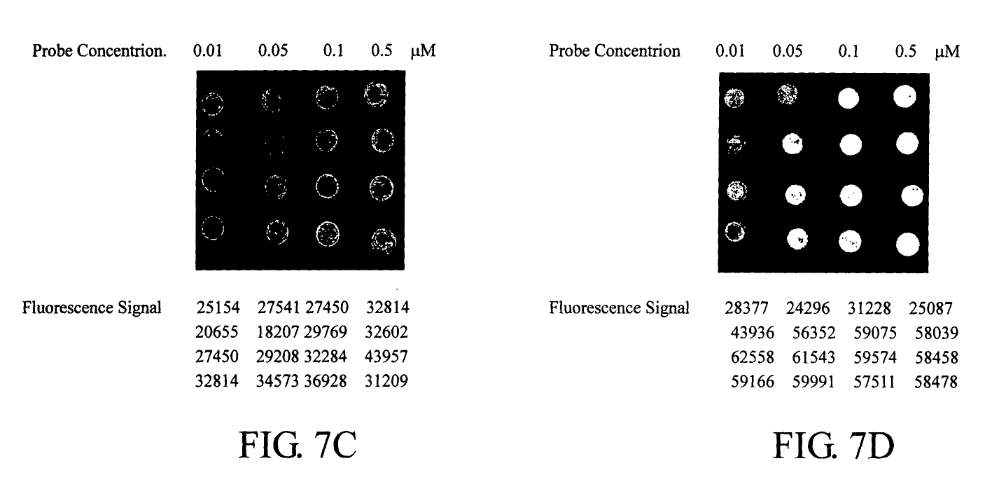

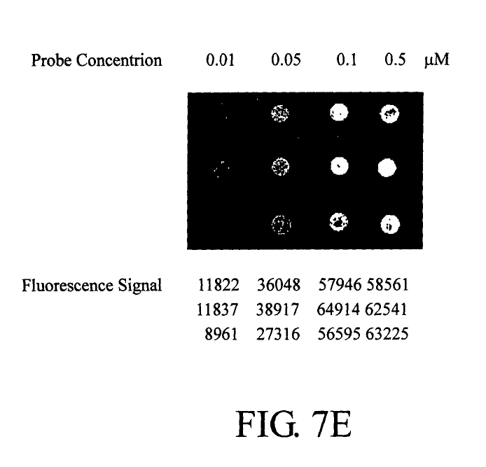

Moreover, the results are compared with different probe concentrations. The biological molecule probe is 0.01, 0.05, 0.1, or 0.5 μM. The fluorescent-labeled sample is 0.5 μM (FIG. 7A), 1.0 μM (FIG. 7B), 5.0 μM (FIG. 7C), 10 μM (FIG. 7D) or 0.5 μM (FIG. 7E). The results shown in FIGS. 7A˜7D were performed using the conventional hybridization method for 4 hours at 40° C. The result shown in FIG. 7E was acheived using the reactor for microarray of the present invention under alternating voltage ±10 V, 60 Hz for 30 min at room temperature. Comparing the two results, the biological molecule hybridization rate is effectively raised by the reactor and method of the present invention. In contrast, the result obtained by the conventional hybridization method is not consistent, and usually takes longer or requires higher concentrations of sample solution. Raising the concentration of the sample solution is not effective to enhance the performance, since mixing of the sample solution may be insufficient to achieve good performance. The results by the reactor of the present invention are more consistent.

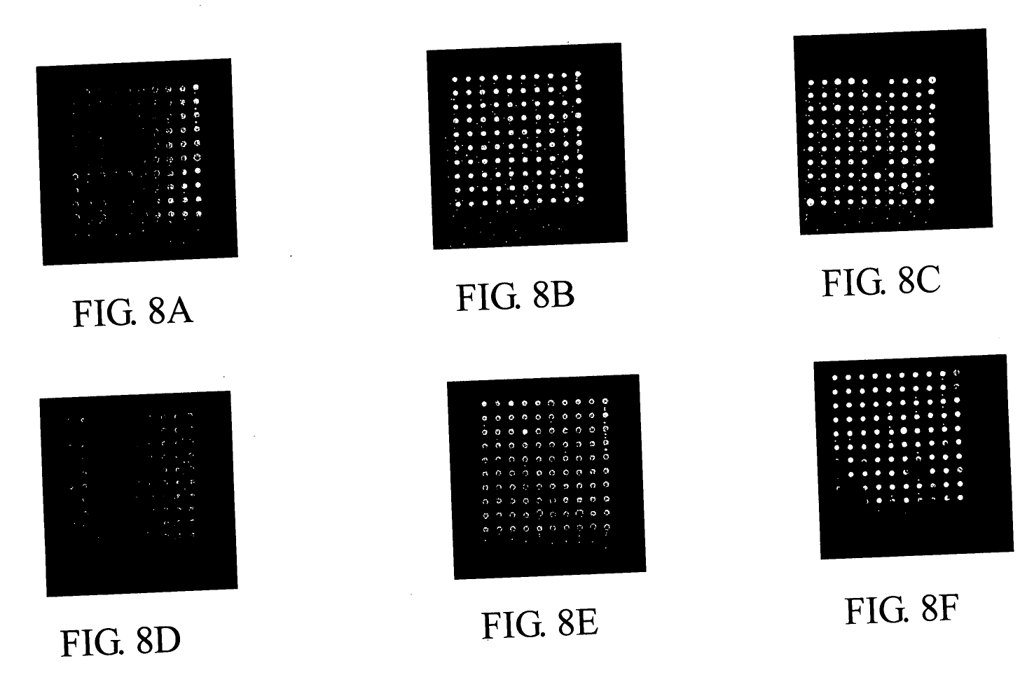

Next, the effects of the reactor of the present invention and conventional hybridization reactor are compared. The result shown in FIG. 8A was acheived using the reactor for microarray of the present invention under alternating voltage ±10 V, 60 Hz for 30 min in the presence of 10 nM sample solution. The results shown in FIGS. 8B-BF were performed using the conventional hybridization reactor in the presence of the same sample solution for 1 hour (FIG. 8B), 2 hours (FIG. 8C), 4 hours (FIG. 8D), 12 hours (FIG. 8E), and 16 hours (FIG. 8F). The results show that using the reactor of the present invention is more effective than the conventional reactor.

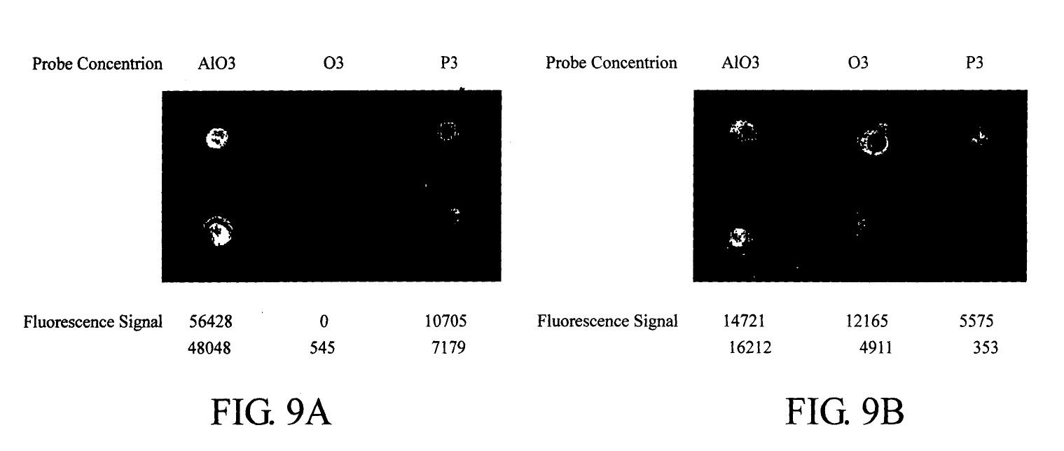

Furthermore, the hybridization effect for biological molecule probe with different degrees of freedom using the reactor for microarray of the present inveniton was assayed. Biological molecules with different degrees of freedom indicate that the probe is immobilized on the substrate by different linkers, for example, the structure of A103 used herein is 5′-amino linker-TTT TTT TTT TTT TTT TTT-(probe sequence)-3′, the structure of O3 is 5′-TTT TTT TTT TTT TTT-(probe sequence)-3′, and the structure of P3 is 5′-amino linker-(probe sequence)-3′. A concentration of the three biological molecule probe are all 0.5 μM, and the sample solution is also 5 μM. The results shown in FIG. 9A were acheived using the reactor for microarray in the present invention under alternating-voltage ±10V, 60 Hz for 30 min. The results shown in FIG. 9B were performed using the conventional hybridization method for 30 min. It is found that the effect acheived by the reactor of the present invention is significantly enhanced and more specific than with the conventional method. With the alternating current, the O3 probe does not attach to the substrate and nonspecific reaction is also avoided. For probes with different degrees of freedom, the probe with higher degree of freedom such as A103 has better reaction result than that with lower degrees of freedom such as P3.

In conclusion, the reactor for microarray of the present invention effectively increases the biochemical reaction. In addition, the examples of oligo microarray show that samples with high concentration reach the diffusion equilibrium in a shorter time interval, the alternating field has little or no effect on the diffusion, and the hybridization result has no significant difference from the conventional method. However, the alternating field has a significant effect on the sample with low concentration and the hybridization result is obviously better than with the conventional method. Moreover, the reliability of the hybridization using the conventional method is proven by the low recurrence of the result. The hybridization controlled by alternating field also has consistent results. Therefore, accuracy and reliability are enhanced with the reactor for microarray of the present invention.

The molecular weight of biological molecules is relatively high, and biological molecules perform some interactions resulting in low diffusion rate and uneven distribution thereof when the reaction is performed without external force. Therefore, hybridization result using the conventional method has poor reliability. On the contrary, using the reactor for microarray of the present invention, the charged biological molecules can follow the electrical field, and the interacting biological moleucles can separate from the non-interacting biological molecules, more evenly distributing the sample solution. Accordingly, the alternating field's better hybridization results show experimental support.

Furthermore, the results show that the hybridization experiences no significant improvement when the probe concentration exceeds a threshold. For example, the results of 0.1 and 0.5 μM probes are not significantly different, indicating that hybridization reaches saturation when the probe concentration exceeds a threshold. It also indicates that high probe concentration ensures the hybridization, however, the probe tightly immobilized on the chip creates a 3-dimensional barrier to the hybridization, reducing the reaction space for each probe, with hybridization results becoming worse than with low probe concentration. Therefore, appropriate concentration of the probe is an important parameter for better hybridization and also saves cost.

While the invention has been particularly shown and described with the reference to the preferred embodiments thereof, it will be understood by those skilled in the art that various changes in form and details may be made without departing from the spirit and scope of the invention.

What is claimed is:

1. A reactor for microarray, comprising:
a first member comprising a fillister for a sample solution,
a second member disposed on the first member, and
at last two electrodes disposed on the second member to contact the sample solution.

2. The reactor for microarray as claimed in claim 1, wherein the first and the second members are composed of organic or inorganic materials.

3. The reactor for microarray as claimed in claim 2, wherein the organic materials comprises resin, synthetic resin, or synthetic polymer, wherein said synthetic polymer comprises polyethylene, polystyrene, polypropylene, or polyvinyl chloride.

4. The reactor for microarray as claimed in claim 2, wherein the inorganic materials comprises metal, ceramic, silicon, or glass.

5. The reactor for microarray as claimed in claim 1, wherein the second member further comprises a plurality of pores.

6. The reactor for microarray as claimed in claim 1, wherein the sample solution comprises a molecule.

7. The reactor for microarray as claimed in claim 6, wherein said molecule is an organic molecule, an inorganic molecule or a biological molecule.

8. The reactor for microarray as claimed in claim 7, wherein said biological molecule comprises nucleic acid, oligonucleotide, protein or peptide.

9. The reactor for microarray as claimed in claim 1, further comprising a second pair of electrodes disposed on the second member.

10. The reactor for microarray as claimed in claim 1, further comprising one electrode corresponding to the pair of electrodes on the second member.

11. The reactor for microarray as claimed in claim 1, 9, or 10, wherein two or more electrodes are used to generate one or more electrical fields.

12. The reactor for microarray as claimed in claim 1, 9, or 10, wherein the electrodes are composed of Au, Ag, Cu, Ni, Pt, or stainless steel.

13. The reactor for microarray as claimed in claim 1, 9, 10, wherein the first member, the second member, and the electrodes are inert to the sample solution.

14. The reactor for microarray as claimed in claim 1, wherein the second member further embeds a microarray.

15. The reactor for microarray as claimed in claim 1, wherein the first and the second members are formed integrally.

16. A reactor for microarray, comprising:
a first member comprising a first fillister for a microarray containing a reaction region;
a second member removably disposed on the first member with a second fillister corresponding to the reaction region; and
at last two electrodes disposed on the second fillister.

17. The reactor for microarray as claimed in claim 16, wherein the first and the second members are composed of organic or inorganic materials.

18. The reactor for microarray as claimed in claim 17, wherein said organic material comprises resin, synthetic resin, or synthetic polymer, wherein said synthetic polymer comprises polyethylene, polystyrene, polypropylene, or polyvinyl chloride.

19. The reactor for microarray as claimed in claim 17, wherein said inorganic material comprises metal, ceramics, silicon, or glass.

20. The reactor for microarray as claimed in claim 16, wherein the second member further comprises a plurality of pores.

21. The reactor for microarray as claimed in claim 16, further comprising a second pair of electrodes disposed on the second member.

22. The reactor for microarray as claimed in claim 16, further comprising one electrode corresponding to the pair of electrodes on the second member.

23. The reactor for microarray as claimed in claim 16, 25, or 26, wherein two or more electrodes are used in combination to generate one or more electrical fields.

24. The reactor for microarray as claimed in claim 16, 25, or 26, wherein the electrodes are Au, Ag, Cu, Ni, Pt, or stainless steel.
